(19) United States
(12) Patent Application Publication
(10) Pub. No.: US 2025/0185540 A1
(43) Pub. Date: Jun. 12, 2025

(54) HEADER HEIGHT CONTROL DEVICES, SYSTEMS, AND METHODS

(71) Applicant: Ag Leader Technology, Ames, IA (US)

(72) Inventors: Scott Eichhorn, Ames, IA (US); Roger Ziuelke, Huxley, IA (US); Tony Woodcock, Ames, IA (US)

(21) Appl. No.: 18/974,482

(22) Filed: Dec. 9, 2024

Related U.S. Application Data
(60) Provisional application No. 63/607,227, filed on Dec. 7, 2023.

(51) Int. Cl. A01D 41/14; A01D 45/02

(52) U.S. Cl. CPC A01D 41/141; A01D 45/021

(57) ABSTRACT

A header height sensor and adjustment system capable of differentiating between the ground and object above the ground. The system is able to differentiate between lodged/downed stalks and the ground. The system includes one or more non-contact sensors, such as Time-of-Flight (ToF) sensor and/or radar sensors. The system may optionally include a contact sensor. The disclosed header height sensor and adjustment system is able to automatically or semi-automatically adjust the height of the header in response to detected objects and terrain in order to maximize yield (e.g., lowering to harvest lodged stalks) and avoid header damage (e.g., raising to avoid debris or contour terrain).

### CROSS-REFERENCE TO RELATED APPLICATION(S)

This application claims the benefit under 35 U.S.C. § 119 (e) to U.S. Provisional Application 63/607,227, filed Dec. 7, 2023, and entitled Header Height Control Devices, Systems and Methods, which is hereby incorporated herein by reference in its entirety for all purposes.

### TECHNICAL FIELD

The disclosure relates to agricultural harvesters and harvesting operations.

### BACKGROUND

While the need for header height control is clear, it is often difficult for combine operators to accurately position the combine header relative to the ground. The view from the combine cab and the presence of crop material in the combine header prevent the operator from getting an optimal view of the header that allows easy adjustment to control relative distance to the ground. Additionally, the changing shape and slope of the ground (i.e. soil) surface creates the need for constant adjustment while traversing the field during a harvest operation. Nearly all known combine header height systems rely on a physical element, such as a sensor arm (shown, for example at 13 in FIGS. 5, 7-8) extending from the underside of the header that contacts the ground surface beneath the header.

For row crops like corn, the physical element for measuring header height is positioned underneath a row divider and is designed to hang down between the rows in what is called the inter-row space. The sensor arm is attached to a sensor that measures the rotational position of the arm. This position is translated to a height above ground that is used as an input for the control system to control the header height above ground to a user-defined setting. Header height control systems typically use one to three sensors as inputs. Using two or more sensors allows for both up-down height control and left-right angle control.

For corn harvesting, one of the problems with the physical arm-type sensors happens when there are corn stalks that may be lodged (or falling over). Lodging may be caused by several factors including high winds. These lodged corn stalks may still be above the ground depending on where the stalk bends or breaks. When corn stalks are laying across the inter-row space, the row divider tip (shown, for example at 4 throughout) can pass over the stalks. This causes the physical elements to ride on top of the stalks, which makes the header height system think the lodged stalks are the ground. This in turn causes the header control system to raise the header in error.

These prior known header control systems then get stuck in this “high” error state until the physical elements can touch the ground again after harvester passes by the lodged stalks. Further, the ears on these lodged stalks are never gathered into the head, decreasing overall yield. Instead, they are left on the ground to rot or grow as unwanted volunteer corn. Stakeholders then lose yield and profit. The current solution on known system is for the operator to disable the automatic height control system and manually lower the header.

Lodged corn plants may also cause the same effect for non-contact sensors (like ultrasonic or radar) that don't have the capability to discern between the soil surface and crop material.

### BRIEF SUMMARY

Disclosed herein are various sensors and related systems and methods for a header height control system that uses a multi-point, non-contact sensor that can distinguish between the soil (or ground) surface and crop material (e.g. lodged stalks) or other non-soil debris passing underneath the header. In one example the multi-point, non-contact sensor is an optical (infrared) laser time-of-flight (ToF) sensor array that uses a square grid.

In Example 1, a header height sensor system, comprising at least one non-contact distance sensor disposed on a header row unit, a processor in communication with the at least one non-contact distance sensor, and a height adjustment system configured to automatically adjust a height of the header row unit in response to detected distances by the at least one non-contact distance sensor.

Example 2 relates to the header height sensor system of any of Examples 1 and 3-9, wherein the at least one non-contact distance sensor is a Time-of-Flight (ToF) sensor.

Example 3 relates to the header height sensor system of any of Examples 1-2 and 4-9, wherein the at least one non-contact distance sensor is an array of Time-of-Flight (ToF) sensors.

Example 4 relates to the header height sensor system of any of Examples 1-3 and 5-9, wherein the system is configured to detect objects above ground as the header row unit passes over by detecting differences in distances between projection points of the array of Time-of-Flight sensors.

Example 5 relates to the header height sensor system of any of Examples 1˜4 and 6-9, wherein the height adjustment system is configured to lower the height of the header row unit in response to detecting lodged stalks.

Example 6 relates to the header height sensor system of any of Examples 1-5 and 7-9, wherein the array of Time-of-Flight sensors sample distances at about 10 Hz or greater.

Example 7 relates to the header height sensor system of any of Examples 1-6 and 8-9, wherein adjustments are made by the height adjustment system after threshold number of samples detect an object above ground.

Example 8 relates to the header height sensor system of any of Examples 1-7 and 9, wherein the threshold number of samples is six or greater.

Example 9 relates to the header height sensor system of any of Examples 1-8, further comprising at least one radar sensor in communication with the processor configured to sense distance to ground.

In Example 10, a header height sensor system, comprising a first non-contact height sensor disposed on a corn header snoot, and a processor in communication with the first non-contact height sensor, wherein the processor is configured to detect objects above a ground by samples of distance data from the first non-contact height sensor.

Example 11 relates to the header height sensor system of any of Examples 10 and 12-19, wherein the first non-contact height sensor is a Time-of-Flight (ToF) sensor array configured to measure height at more than one projection point.

Example 12 relates to the header height sensor system of any of Examples 10-11 and 13-19, wherein the first non-contact height sensor is configured to measure height at at least four projection points.

Example 13 relates to the header height sensor system of any of Examples 10-12 and 14-19, wherein an object above the ground is detected when there is a threshold amount of difference in the measured heights.

Example 14 relates to the header height sensor system of any of Examples 10-13 and 15-19, further comprising a header height adjustment mechanism wherein the processor is commands adjustments to a header height in response to detected objects.

Example 15 relates to the header height sensor system of any of Examples 10-14 and 16-19, further comprising at least one contact sensor disposed on a superior surface of the corn header snoot configured to detected lodged stalks passing over the corn header snoot.

Example 16 relates to the header height sensor system of any of Examples 10-15 and 17-19, further comprising at least one forward facing vision sensor configured to detect changes to terrain slope.

Example 17 relates to the header height sensor system of any of Examples 10-16 and 18-19, further comprising a header height adjustment mechanism wherein the processor is commands adjustments to a header height in response to changes in terrain slope.

Example 18 relates to the header height sensor system of any of Examples 10-17 and 19, further comprising a memory in communication with the processor, wherein locations for detected objects are stored in the memory.

Example 19 relates to the header height sensor system of any of Examples 10-18, wherein the first non-contact height sensor is disposed at a tip of the corn header snoot and further comprising a second non-contact height sensor disposed at a rear of the corn header snoot.

In Example 20, a system for adjusting a corn header height, comprising a first Time-of-Flight (ToF) sensor array disposed at a tip of a snoot configured to detect height at more than one projection point, a second ToF sensor array disposed at a rear of a snoot configured to detect height at more than one projection point, a processor in communication with the first ToF sensor and the second ToF sensor configured to compare heights at each of the projection points to determine if an lodged stalk is beneath the snoot, and a corn header height adjustment mechanism configured to be commanded by the processor to lower when lodged stalks are beneath the snoot.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1A shows an exemplary combine harvester with corn head, according to one implementation.

FIG. 1B is a schematic view of the system implemented on an harvester, according to one implementation.

FIG. 1C is a system diagram of the header height system, according to one implementation.

FIG. 2 is a side view of a corn header row unit with ToF sensor placement, according to one implementation.

FIG. 3 is a top view of a corn header row unit with ToF sensor placement, according to one implementation.

FIG. 4 is a side view of a corn header row unit with ToF sensor field of view, according to one implementation.

FIG. 5 is a side view of a corn header row unit with ground contact element for measuring height, according to one implementation.

FIG. 6 is a top view of a corn header row unit with a lodged corn stalk in the inter-row space, according to one implementation.

FIG. 7 is a side view of a corn header row unit with a ground contact element being pushed up by lodged corn plants, according to one implementation.

FIG. 8 is a side view of a corn header row unit showing the effect of lodged corn causing head to be raised, according to one implementation.

FIG. 9 is a side view of a corn header row unit with a ToF sensor detecting both lodged corn and ground, according to one implementation.

FIG. 10 is a side view of a corn header row unit with a ToF sensor and radar sensor for measuring ground height and detecting lodged corn, according to one implementation.

FIG. 11 is a side view of a corn header row unit with ToF ground height sensors and contact element for detecting lodged corn, according to one implementation.

FIG. 12 is a side view of a corn header row unit with ToF ground height sensors and contact element on top of snoot to detect lodged corn being picked up, according to one implementation.

FIG. 13 is a side view of a corn header row unit with ToF sensors and forward looking sensor to detect both lodged corn and upcoming ground height, according to one implementation.

FIG. 14 shows an exemplary ToF sensor array with a 3×3 grid of distance measurement points, according to one implementation.

FIG. 15 shows an exemplary ToF sensor array with corn stalk detected between sensor and ground, according to one implementation.

### DETAILED DESCRIPTION

Discussed herein are various devices, systems, and methods for a header height sensor and adjustment system capable of differentiating between the ground and object above the ground. For example the disclosed system is able to differentiate between lodged/downed stalks and the ground. In some implementations, the system includes one or more non-contact sensors, such as Time-of-Flight (ToF) sensor and/or radar sensors. The system may optionally include a contact sensor. The disclosed header height sensor and adjustment system is configured to automatically or semi-automatically adjust the height of the header in response to detected objects and terrain in order to maximize yield (e.g., lowering to harvest lodged stalks) and avoid header damage (e.g., raising to avoid debris or contour terrain).

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/776,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. Patent Application 63/609,758, filed Dec. 13, 2023, entitled “Magnetic Stripper/Deck Plate Sensing System,” U.S. Patent Application 63/626,744, filed Jan. 30, 2024, entitled “Grain Cart Unloading Sensor and Unload Control,” U.S. Patent Application 63/646,038, filed May 13, 2024, entitled “Seed Tube Camera and Related Devices, Systems, and Methods,” U.S. Patent Application 63/646,068, filed May 13, 2024, entitled “Seed Tube Camera and Related Devices, Systems, and Methods,” U.S. Patent Application 63/651,831, filed May 24, 224, entitled “Non-Contact Methods for Interactions in Navigational Space of Relatively Located Mobile Systems, and Related Devices and Systems,” U.S. Patent Application 63/654,634, filed May 31, 2024, entitled “Equipment Thermal Monitoring System and Associated Methods and Devices,” U.S. Patent Application 63/667,546, filed Jul. 3, 2024, entitled “Cover for Port Openings,” U.S. Patent Application 63/667,530, filed Jul. 3, 2024, entitled “Agricultural Seed Meters and Related Devices, Systems and Methods,” U.S. Patent Application 63/685,000, filed Aug. 20, 2024, entitled “Crop Sensor Wands and Related Devices, Systems, and Methods,” U.S. Patent Application 63/682,229, filed Aug. 12, 2024, entitled “Integrated Crop Sensor and GPS Steering Systems and Related Devices and Methods,” U.S. Patent Application 63/683,149, filed Aug. 14, 2024, entitled “Seed Tube Camera and Related Devices, Systems, and Methods,” U.S. Patent Application 63/710,492, filed Oct. 22, 2024, entitled “Crop Sensors and Related Devices, Systems, and Methods,” U.S. Patent Application 63/710,641, filed Oct. 23, 2024, entitled “Agricultural Sprayer Boom Flush, Chemical Detection and Chemical Concentration Detection,” U.S. Patent Application 63/720,611, filed Nov. 14, 2024, entitled “Liquid Product Distribution for See and Spray Systems,” U.S. Patent Application 63/722,916, filed Nov. 20, 2024, entitled “Agricultural Harvesting Systems and Related Devices and Methods,” U.S. Patent Application 63/722,934, filed Nov. 20, 2024, entitled “Sprayer PWM Nozzle Valve Pressure Drop Mitigation,” U.S. Patent Application 63/723,400, filed Nov. 21, 2024, entitled “Systems, Methods and Devices for Increasing Machine Operating Range Using PWM and Dynamic Pressure Range Control,” U.S. Patent Application 63/723,436, filed Nov. 21, 2024, entitled “Seed Tube Camera and Related Devices, Systems, and Methods,” and U.S. Patent Applicant 63/727,579, filed Dec. 3, 2024, entitled “Smart Shift System for Automatic AB Line Adjustment in Agricultural Operations and Related Devices and Methods,” each of which is incorporated herein by reference.

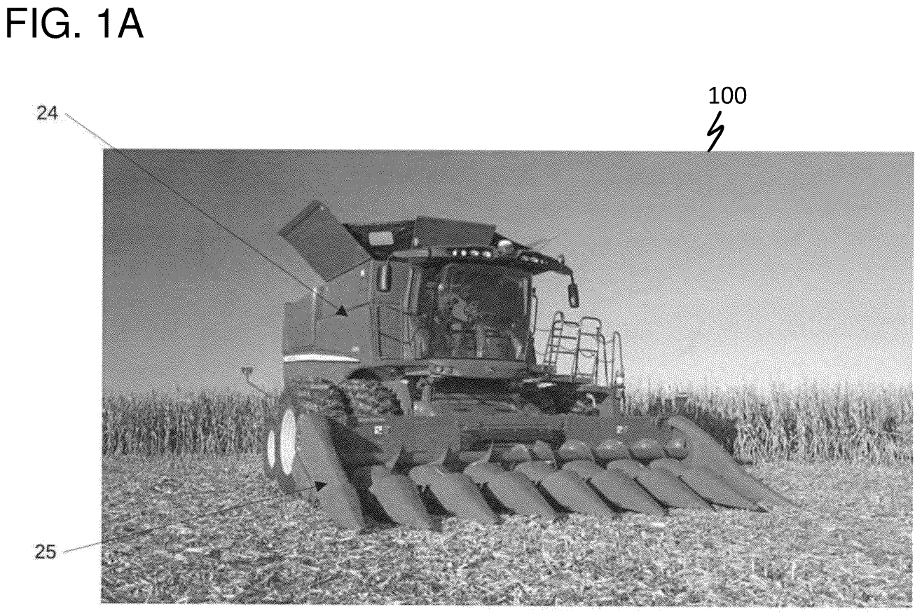

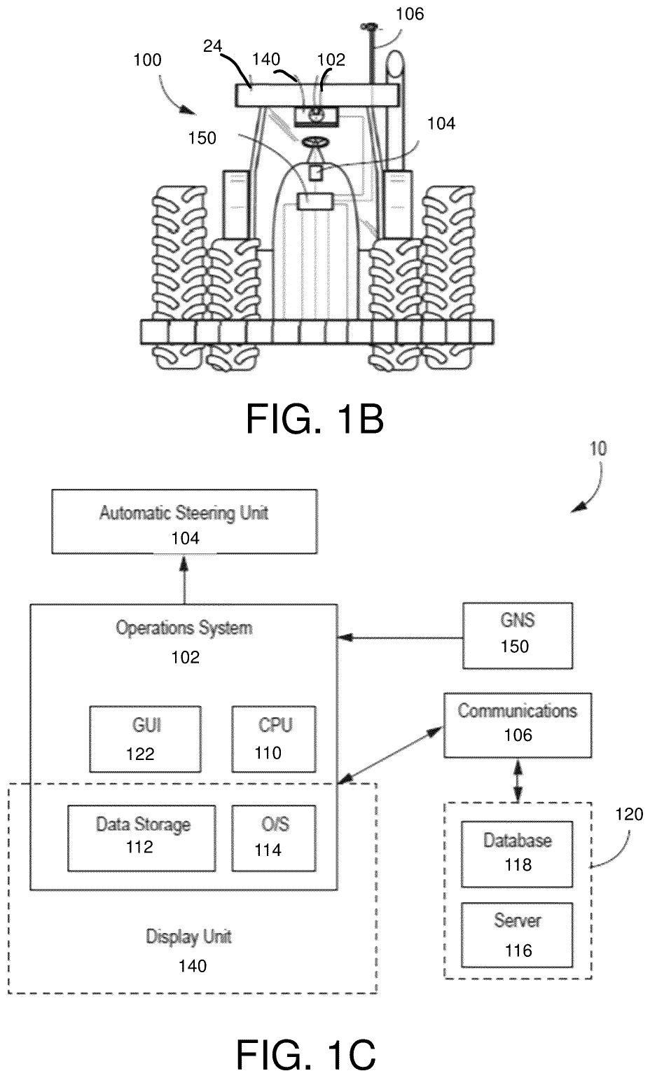

Turning to the drawings in greater detail, FIG. 1A depicts a combine harvester 24 with a corn head 25 implementing the system 100, as would be understood.

FIGS. 1B-1C depict exemplary implementations of the header height system 100 components fitted to an agricultural vehicle 24, such as a combine harvester 24. It is further understood that the components depicted in FIGS. 1B-1C are optional, and can be utilized or omitted in the various claimed implementations, and that certain additional components may be required to effectuate the various processes and systems described herein. Such additional components may include hardware, software, firmware, and other electronic components that would be known and appreciated by those of skill in the art.

As shown in FIG. 1B, the header height system 100 has an operations system 102 that comprises or is configured to be operationally integrated with a steering unit 104, such as SteerCommand®, and an optional communications component 106. The system 100 may be operationally integrated with at least one in-cab display 140, such as an InCommand® display 140, or other suitable display 140 understood in the art. It is appreciated that certain of these displays 140 feature touchscreens, while others are equipped with necessary components for interaction with the various prompts and adjustments discussed herein, such as via a keyboard or other interface.

In various implementations, the system 100 is also operationally integrated with a GNSS or GPS unit 150, such as a GPS 7500, such that the system 100 is configured to input positional data for use in recording data, as would be readily appreciated from the present disclosure.

As shown in FIG. 1C, in various implementations, the operations system 102 is optionally in operational communication with the automatic steering unit 104 or controller 104, the communications component 106, and/or GNSS 150. In certain of these implementations, the operations system 102 is housed in the display 140, though the various components described herein can be housed elsewhere, as would be readily appreciated.

As shown in FIG. 1C, the operations system 102 further has one or more optional processing and computing components, such as a CPU/processor 110, data storage 112, operating system 114, graphical user interface (GUI) 122, and other computing components necessary for implementing the various technologies disclosed herein. It is appreciated that the various optional system components are in operational communication with one another via wired or wireless connections and are configured to perform the processes and execute the commands described herein.

In certain implementations, like that of FIG. 1C, the communications component 106 is configured for the sending and receiving of data for cloud 120 storage and processing, such as to a remote server 116, database 118, and/or other cloud computing components readily understood in the art. Such connections by the communications component 106 can be made wirelessly via understood internet and/or cellular technologies such as Bluetooth, WiFi, LTE, 3G, 4G, or 5G connections and the like. It is understood that in certain implementations, the communications component 106 and/or cloud 120 components comprise encryption or other data privacy components such as hardware, software, and/or firmware security aspects. In various implementations, the operator or enterprise manager or other third parties are able to receive notifications via their mobile phones or other devices.

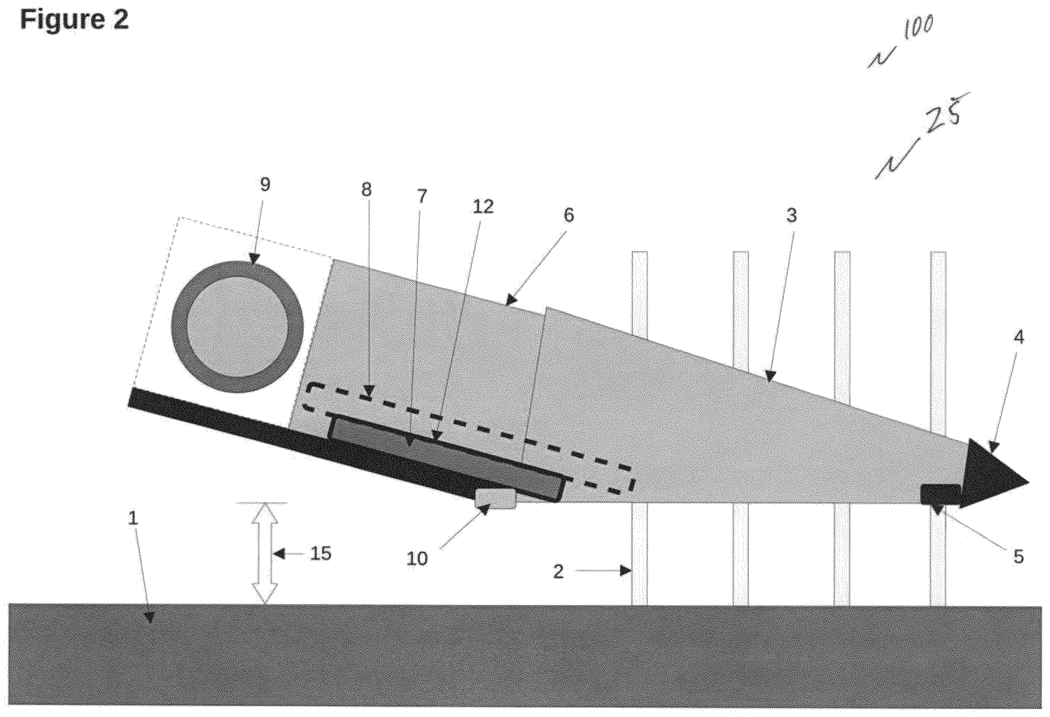

FIG. 2 is an example of one implementation of the header system 100 on a row header 25. FIG. 2 shows the side view of a single row of a row header 25 used for harvesting corn and illustrates the harvesting process as the header 25 moves and corn plants 2 enter the row harvesting elements, such as gathering chains 8, deck plates 12, and stalk rolls 7, as would be generally understood by those of skill in the art. In this implementation, two time-of-flight (ToF) sensor arrays 5, 10 are positioned to measure distances at the front of the snoot 3 (at or near the snoot tip 4) and behind (towards the rear of) the snoot 3.

It would be understood that the snoot 3 is a pivoting element and pivots at the rear near its mounting point 9 to the header 25. In certain implementations, the lowest angle of the snoot 3 may be defined by an adjustable element. This adjustable element (not shown) may be a physical mechanism requiring hand (or tool) adjustment but may also be an electro-mechanical mechanism that may be part of a snoot height adjustment system. While the implementation of FIG. 2 shows the use of two ToF sensor arrays 5, 10, the system 100 may operate with and use a single ToF sensor array.

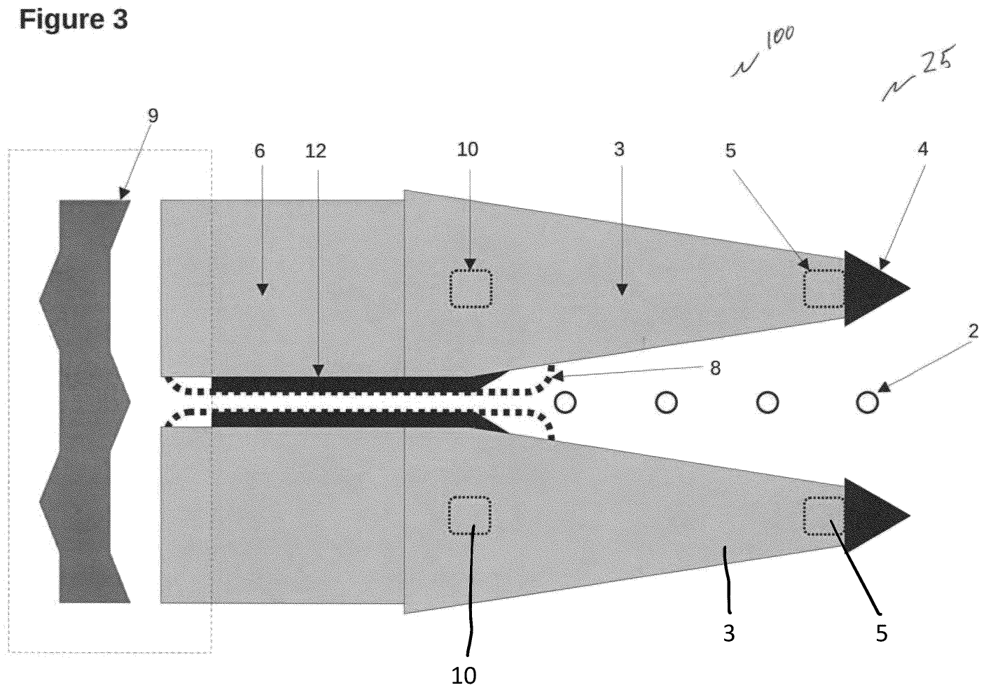

FIG. 3 is the top-down view of the row crop header 25 showing two crop dividers/snoots 3 and a single harvesting row. Here, the ToF sensor arrays 5, 10 are shown in outline because they are mounted on the bottom/ground side of the header 25 and as such would not be visible from the top.

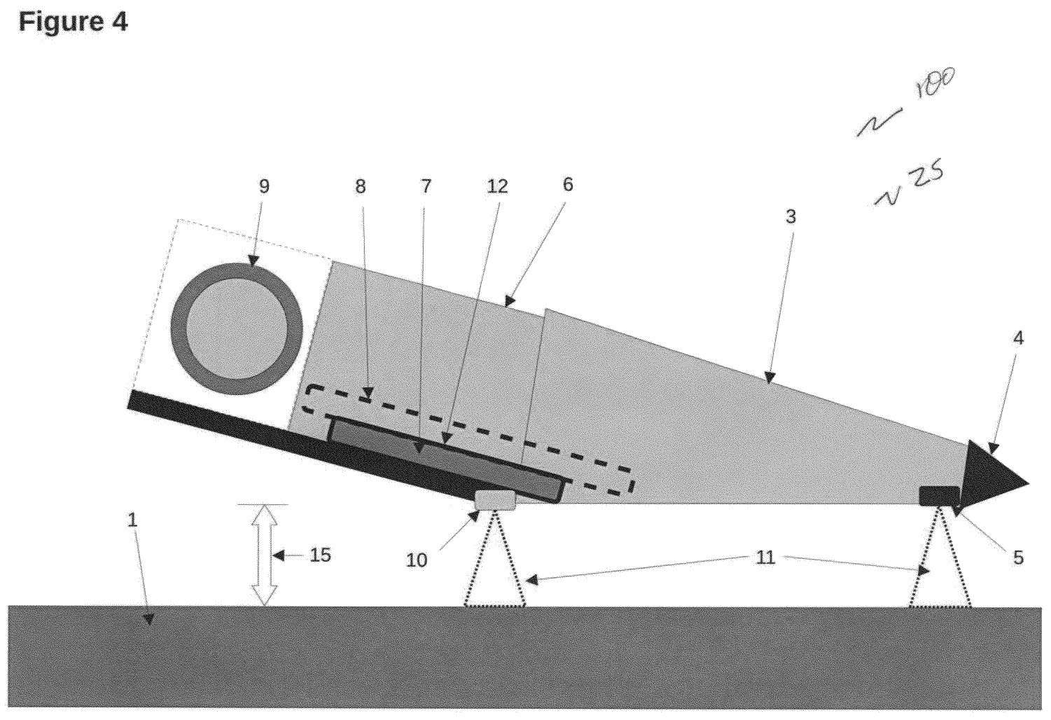

FIG. 4 shows the field of view 11 of the two ToF sensor arrays 5,10, in one implementation. The header height control system 100 will receive the distance information from the two sensor arrays 5, 10 and adjust the header 25 to achieve the desired header height 15 as defined by the operator, system 100, machine learning algorithm, or other preset as would be understood.

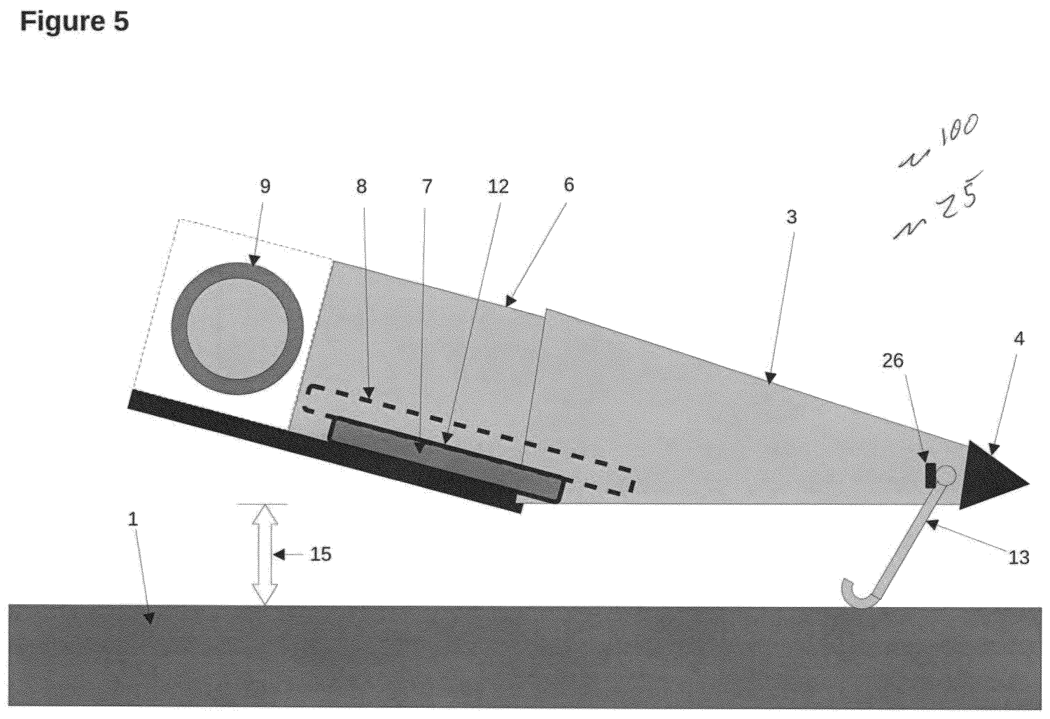

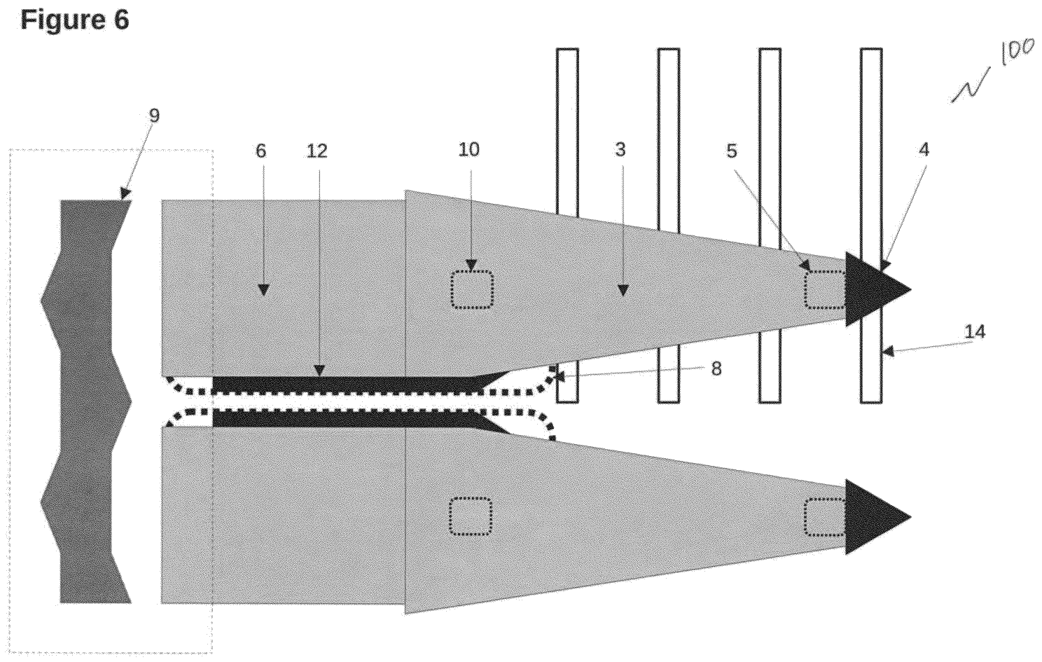

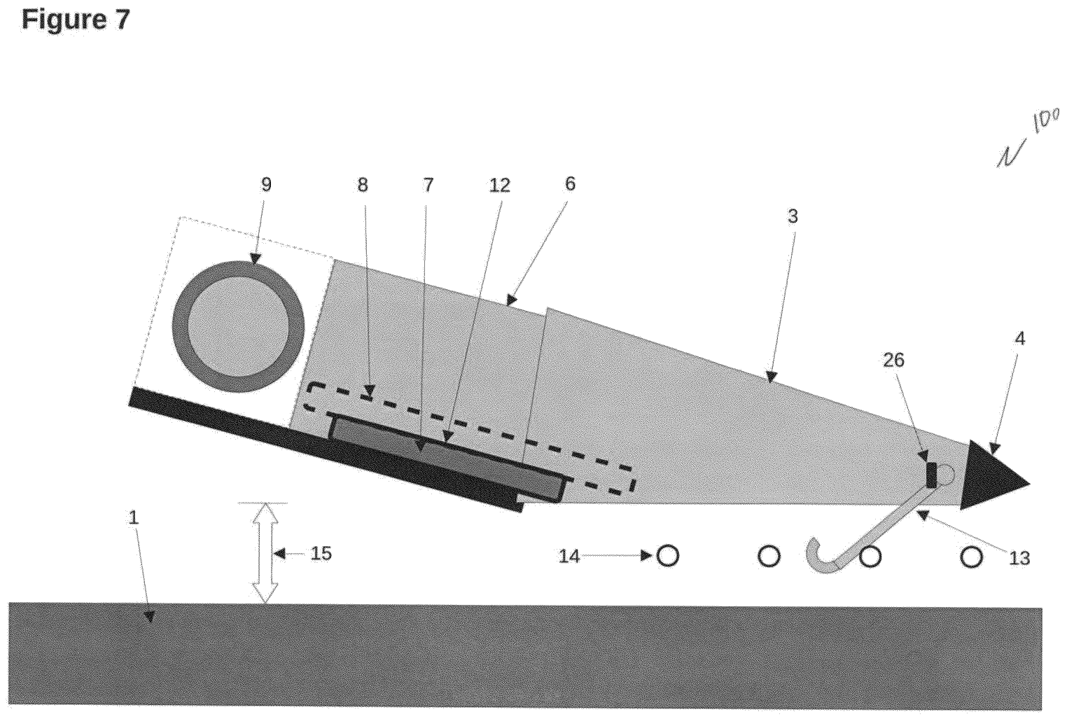

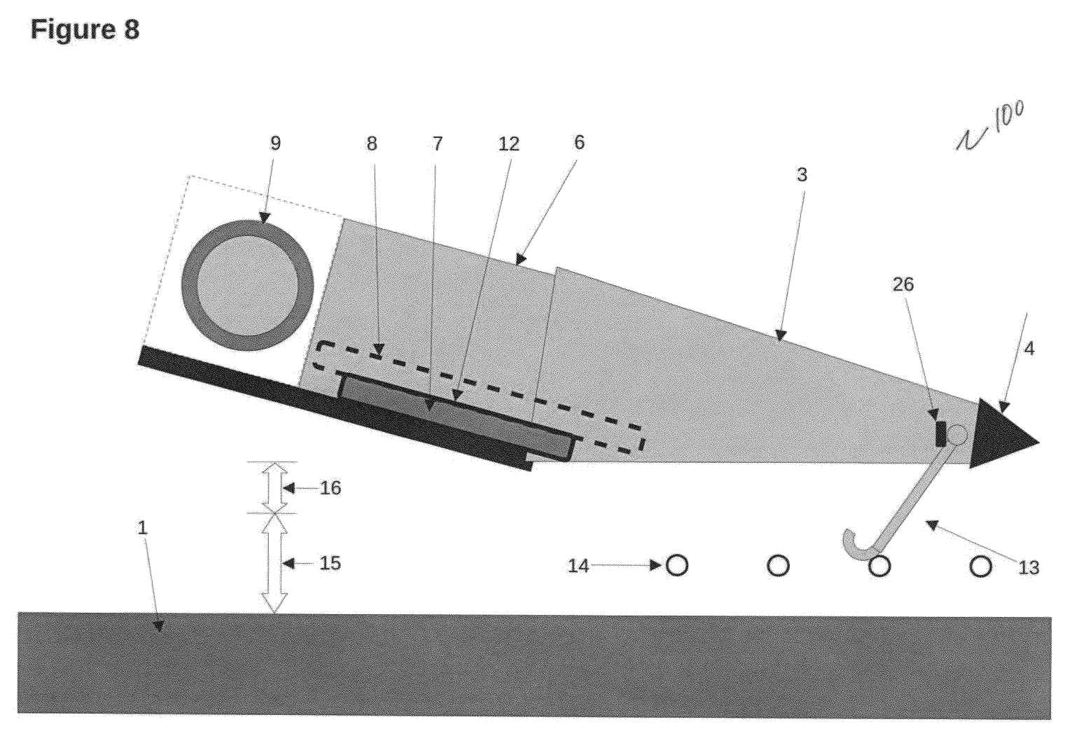

FIG. 5 is a shows a physical element (contact) header height sensor 13. In these implementations, the sensor arm 13 is attached to an electronic sensor 26 that measures the rotational position of the arm 13. As would be understood, the rotational position of the arm 13 translates to a height above ground 1 that is used as an input for the header height system 100 to control the header height 15 above ground 1 to the user-defined setting. If the corn stalks are lodged 14, as shown in FIG. 6, the sensor arm 13 will ride on top of the lodged stalks 14. FIG. 7 shows the contact sensor 13 being deflected by the lodged corn stalks 14. FIG. 8 demonstrates the result of the contact sensor 13, with a prior known system, being pushed up by the stalks 14, where the header 25 is above the desired height and not lifting the lodged stalks 14 off the ground and into the header 25.

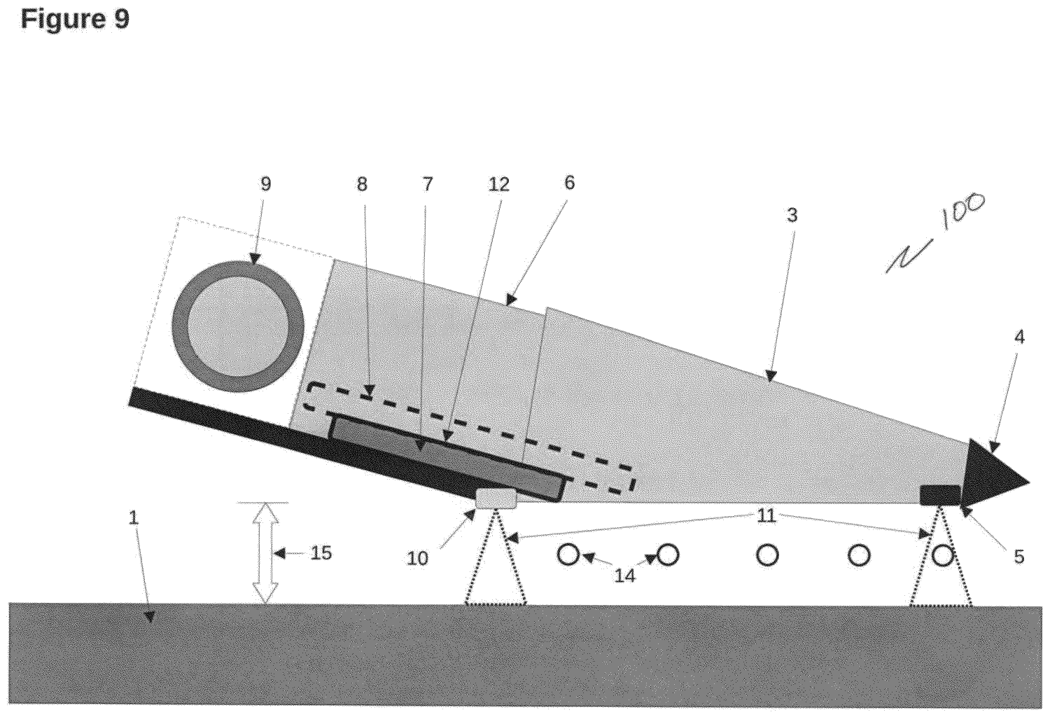

FIG. 9 demonstrates an implementation of the system 100 using one or more ToF sensor arrays 5, 10 to sense the height 15 of the header 25 above the ground 1 when lodged corn 14 is present in the inter-row space.

As would be appreciated, a single ToF sensor array 5, 10 has multiple distance sampling points within its field of view (“FoV”) 11. In most cases, material between the sensor 5, 10 (usually in the form of lodged stalks 14) and the ground 1 does not intercept (or obscure) all sample points in the sensor 5, 10 FoV 11. Thus, the maximum distance sampled will usually come from a reflection off the ground 1. In various implementations, the ground 1 distance measuring algorithm will use all valid distances from the ToF sensor array to 5, 10 determine the distance from the header to the ground-header height 15.

The measured distance points that reflect off the lodged corn 14 will be a shorter distance than the ground 1 distance points. This difference in measured distance allows the system 100 to detect the presence of lodged stalks 14 in the inter-row space passing beneath the header 25. The presence of lodged stalks 14 may result in a visual or audio alarm being presented to the combine operator so they can react and attempt to correct the header height 15 allowing the lodged corn 14 to be picked up by the header 25.

Additionally or alternatively, lodged corn 14 detections may command the header height control system 100 to override the previous/set header height 14 and lower the header 25 to attempt to pick up the lodged corn 14.

In further implementations, lodged corn 14 detections may also be logged and mapped along with their geo-spatial position (as determined by a GNSS receiver 150 on the combine 24). Measuring the location and amount of lodged corn 14 in a field may allow stakeholders to gain a better understanding of the performance and condition of the corn 2 in the field.

In some cases, the material between the sensor 5, 10 and the ground 1 does intercept all sample points in the sensor 5, 10 FoV 11. In this That is, the ground 1 is not visible to the sensor 5, 10 and the distance to the ground 1 measured at that point will be the distance to the lodged corn 14, crop material, or other debris. When implementing the disclosed system 100 the ToF sensors 5, 10 are optionally sampling at a fast rate (˜10-30 Hz) as the harvester 24 is moving through the field. As such, because in all but the most extreme cases, the lodged corn 14 will not completely cover the inter-row space and will leave gaps, where at least one of the ToF sensor array 5, 10 sample points will correctly measure the distance to the ground 1. In these and other implementations, the system 100 may be configured to only adjust a header height 15 or issue a lodged corn 14 alarm when the detected distances include a threshold amount of difference over threshold number of samples. For example, the distance threshold may be greater than about 6 inches and the threshold number of samples may be greater than 6 samples. Of course various other thresholds are possible and would be understood by those of skill in the art. Threshold values may be preset by the system 100, set by an operator, or determined by an artificial intelligence or machine learning model.

The use of multiple ToF sensor arrays 5, 10 may increase the likelihood of correctly sampling the distance to the ground 1. In certain implementations, the control system 100 may not move the header 25 up and down instantaneously, but instead use multiple distance samples over a distance and/or time to minimize the possibility of a single (or small number of) incorrect ground 1 distance measurement.

Certain ToF sensors 10 are mounted below the front of the deck plates 12 and gathering chains 8. As would be understood, the portion of the header 25 should be kept from contacting the ground 1. That is, combine operators do not want the deck plates 12 and gathering chains 8 digging into the ground. This can cause the gathering chains 8 to pick up rocks which can damage the harvester 24. Dirt also wears corn header 24 components. The use of non-contact, ToF sensors 10 allows for measuring distance to the ground 1 without physically touching the ground and potentially disturbing more dirt and debris than is necessary in a harvesting operation.

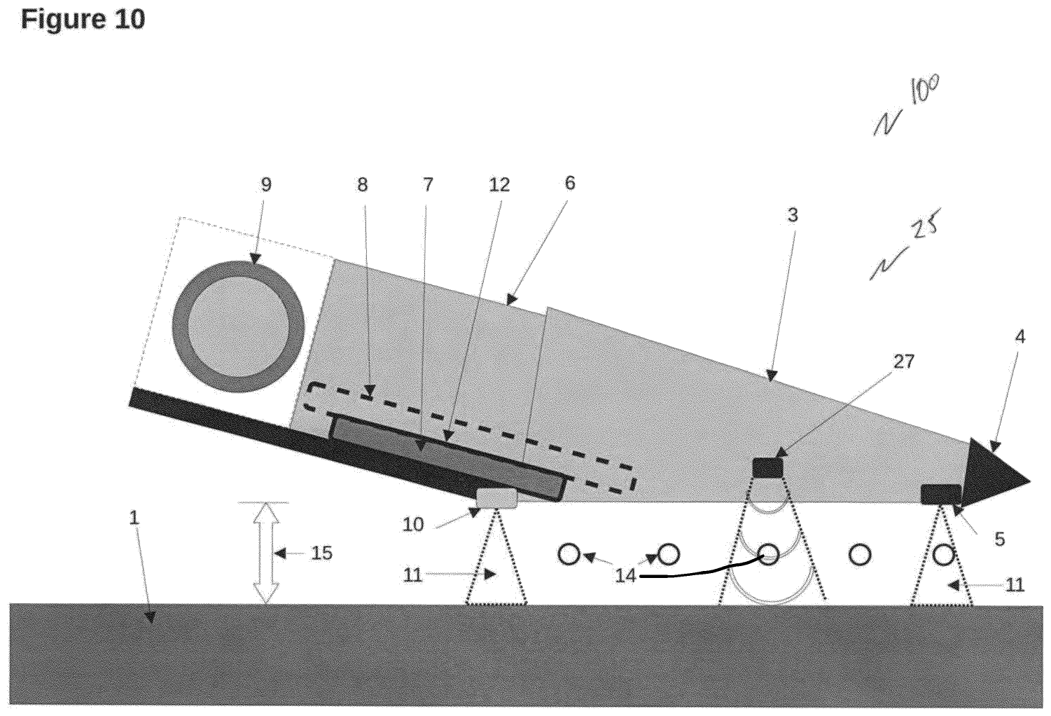

Turning now to FIG. 10, in this implementation the system 100 utilizes a radar sensor 27 to detect the distance to the ground 1. The transmitted signal of the radar sensor 27 shown is not completely absorbed or reflected by the lodged corn 14. Thus, the radar sensor 27 can “see through” the lodged corn 14 to the ground 1 and correctly measure the distance to the ground 1 even when the lodged corn 14 may completely cover the ground and prevent an optical ToF sensor 5, 10 from detecting and measuring the distance to the ground. In certain implementations, the system 100 may include one or more ToF sensors 5, 10, one or more radar sensors 27, and/or any combination thereof.

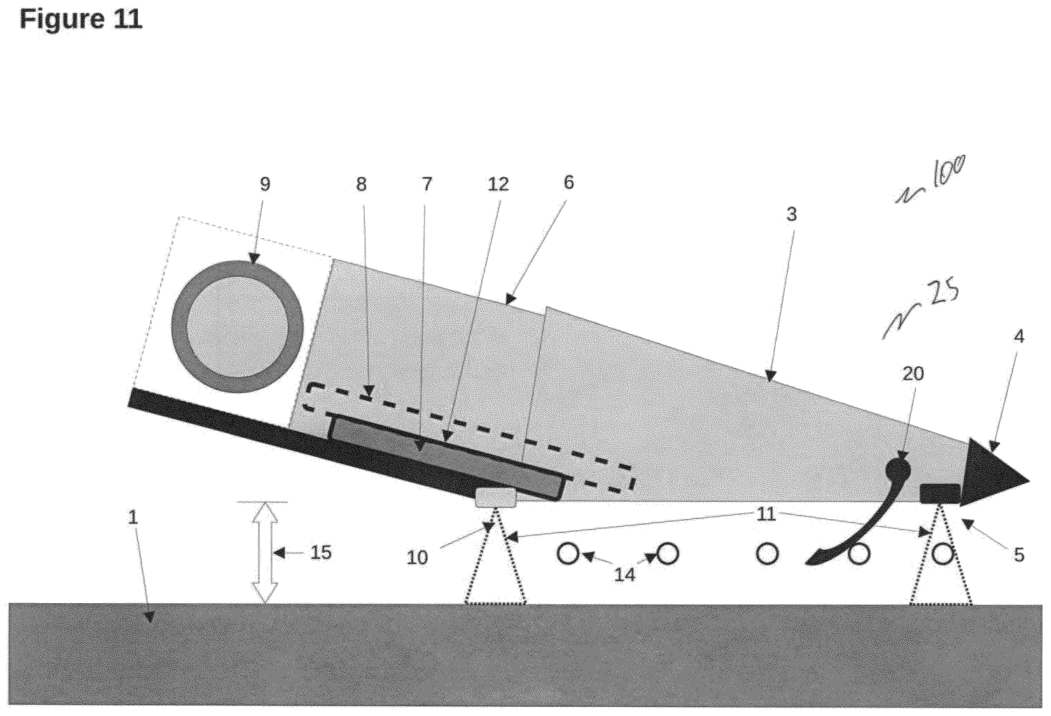

FIG. 11 shows a further implementations of the system 100 having a downward projecting contact sensor 20 in conjunction with one or more non-contact distance sensors 5, 10 (ToF sensor array or radar). The contact sensor 20 may be configured to deflect when it contacts lodged corn 14 passing beneath the header 14. The contact sensor 20 may include a displacement or rotation sensor used to determine the position and movement of the contact sensor 20.

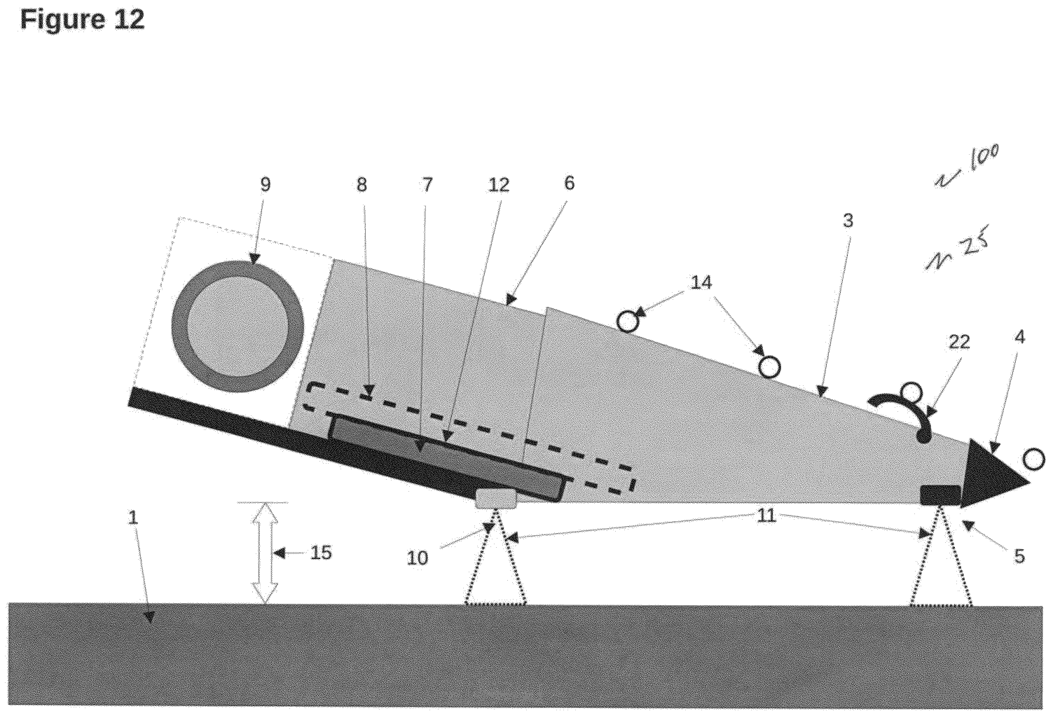

FIG. 12 shows a further implementation of the system 100 with a contact sensor 22 on the top 6 of the snoot 3. In various implementations the top contact sensor 22 is configured to detect lodged stalks 14 being picked up by the snoots 3. When lodged corn 14 is picked up correctly by the header 25, it typically rides up on the top of the snoots 3 as it is rotated and then processed into the harvesting portion of the header 25 that pulls the stalk 2 through and separates the ear from the stalk 2, as would be understood. If lodged corn 14 is detected by the ToF sensor array(s) 5, 10 and the header 25 is lowered in response to the detection, as described herein, the contact sensor 22 on the top of the snoot 3 will detect the lodged corn 14 as the snoot lifts it up and into the header 25.

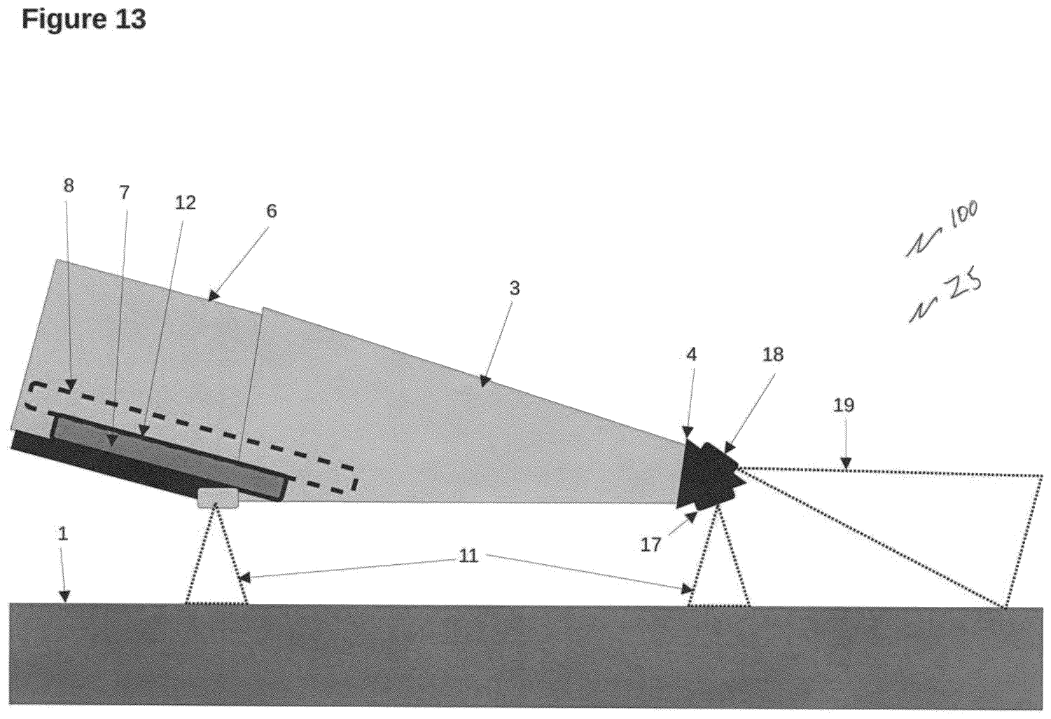

FIG. 13 shows further implementation of the system 100 where the ToF sensor array 5, 10 is integrated into the snoot 3 tip 4. Also in this exemplary implementation is the use of a forward-looking sensor 18, which may be integrated into the snoot 3 tip 4 or positioned above the snoot 3 tip 4. The forward-looking sensor 18 may be a ToF sensor or other sensor array, radar sensor, ultrasonic sensor, camera vision sensor, or the like. In these and other implementations, the forward-looking sensor 18 detects the condition of the inter-row space ahead of the snoot 3. The forward-looking sensor 18 will measure the distance to the ground 1 ahead of the snoot 3 tip 4, which enables sensing of the slope of the ground 1. The header height control system 100 is then able to react to ground 1 height changes due to changes in terrain.

Reacting to and positing the header 24 in accordance this the terrain help to keep the snoot 3 from jamming into the ground and bending the snoot 3. Bent or “wrecked” snoots 3 must be replaced. Some farmers may set the head height extra high to avoid wrecking snoots 3, but this extra height can lead to lost yields as discussed herein and as would be understood by leaving stalks in the field. A forward-looking sensor 18 may allow the header 25 to be ran closer to the ground 1 without increasing the risk of wrecked snoots 3.

The forward-looking sensor 18 may also will detect lodged corn 14 in the inter-row space, which enables the height control system 100 to react accordingly and lower the head 25 to pick up the lodged corn 14 before passing over the lodged corn 14.

The forward-looking sensor 18 may be a camera that provides visual feedback to the combine operator as it is often very difficult for the operator to view the inter-row space during harvest.

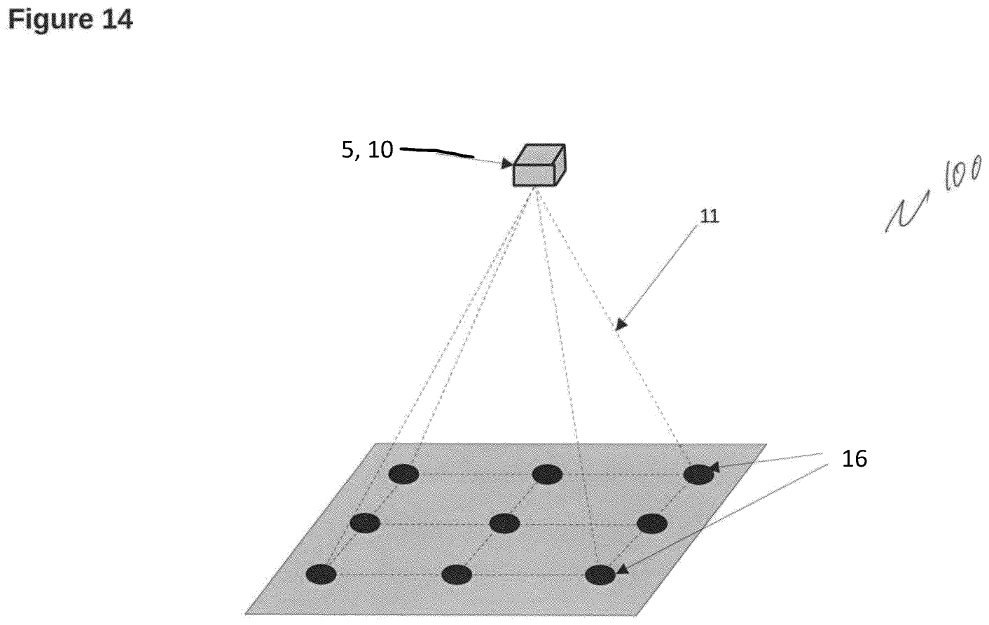

FIG. 14 shows an exemplary a Time-of-Flight (ToF) array sensor 5, 10. The sensor 5, 10 is an array, or grid, of individual ToF sensors each projecting out at a slightly different angle from the sensor origin. Each of the grid points is a projection point 16. Each ToF sensor in the grid (array 5, 10), transmits a short pulse of light (which may be in the infrared range) and measures the time to return, which is then converted to a distance. During a sample period, each ToF sensor attempts to measure a distance for its projection. The data from the ToF Array 5, 10 then is an array of distance measurements. The distance that is measured is along a projection may be at an angle relative to the sensor 5, 10 face, which means that it may not represent the true distance from the sensor to the surface (here the ground) (i.e. the actual distance would be less than what was measured). If needed, the sensor distances will be adjusted based on the projection angle from the sensor face, as would be generally understood by those of skill in the art.

As previously discussed, crop material that enters the space between the ToF sensor array 5, 10 and the ground 1 does not always prevent all the projected points 16 from reaching the ground 1 and then measuring the distance to the ground 1. In that case, the longest measured projection distance still represents the distance to the ground 1.

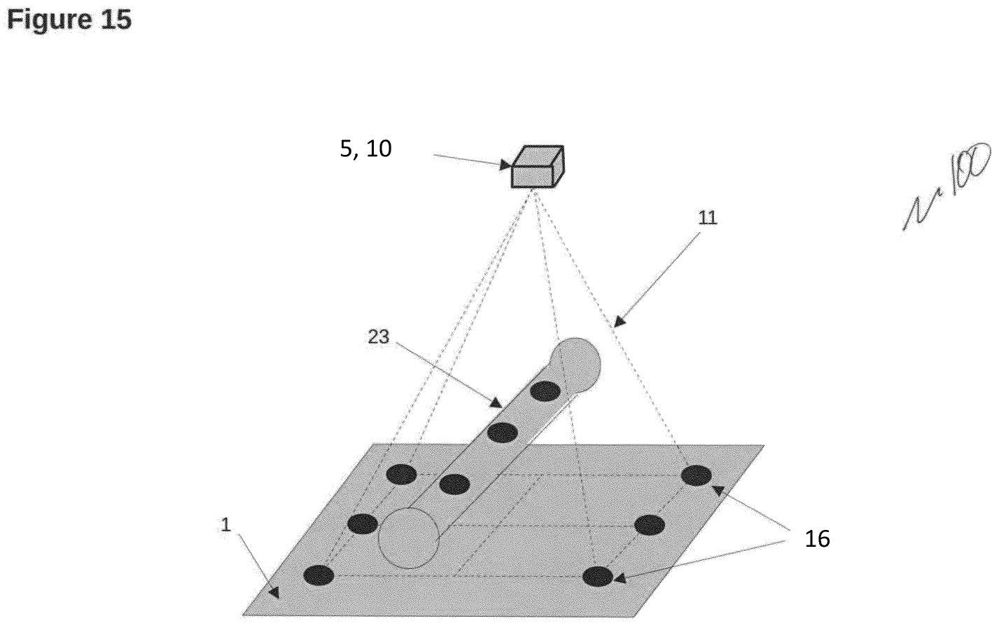

In FIG. 15 the corn stalk 23 is traversing the ToF sensor 5, 10 FoV 11. Three of the ToF projection points 16 are reflecting off the corn stalk 23 and therefore measuring the distance to the corn stalk 23 and not the ground. The remaining projection points 16 are still reflecting off the ground 1 and measuring the distance to the ground 1.

In some cases, it is expected that crop material and/or weeds traversing between the sensor and ground may occasionally intercept all the projection points 16. During harvest the header 25 is moving through the crop which means that the crop material and/or weeds that are obscuring the ground 1 are moving relative to the sensor 5, 10. When there is an opening in the crop material and/or weeds, one or more of the ToF sensor projection points 16 will reach the ground and be able to complete a distance measurement. Therefore, in certain implementations the system 100 includes a method for measuring ground 1 distance will include multiple measurements over time and distance as the sensor 50, 10 (with the header 25) traverses the ground 1. The longest distances will be used as the distance to the ground 1, while the shortest distances may be either be ignored or used to measure the distance to the crop material.

Because the ToF sensor 5, 10 can measure multiple points simultaneously, it is also possible to measure the amount of crop material and/or weeds passing underneath the header 25 in certain implementations. In certain implementations the ToF sensor is used to measure the material passing underneath the sensors 5, 10. The measurement may be a simple binary that shows detection or no detection of crop material and/or weeds underneath the header. It may be a quantity measurement like a percent coverage of crop material. It may be a count measurement where individual plants (or stalks) are detected and counted.

In some implementations the sensor 5, 10 will detect individual plants (e.g. corn stalks) and/or weeds that pass underneath the header 25. When that happens, the header height system 100 will generate a data point that can be mapped on a combine cab display 140 or logged as part of the field operation data and later post-processed.

Although the disclosure has been described with references to various embodiments, persons skilled in the art will recognize that changes may be made in form and detail without departing from the spirit and scope of this disclosure.

What is claimed is:

1. A header height sensor system, comprising:
(a) at least one non-contact distance sensor disposed on a header row unit;
(b) a processor in communication with the at least one non-contact distance sensor; and
(c) a height adjustment system configured to automatically adjust a height of the header row unit in response to detected distances by the at least one non-contact distance sensor.

2. The header height sensor system of claim 1, wherein the at least one non-contact distance sensor is a Time-of-Flight (ToF) sensor.

3. The header height sensor system of claim 1, wherein the at least one non-contact distance sensor is an array of Time-of-Flight (ToF) sensors.

4. The header height sensor system of claim 3, wherein the system is configured to detect objects above ground as the header row unit passes over by detecting differences in distances between projection points of the array of Time-of-Flight sensors.

5. The header height sensor system of claim 4, wherein the height adjustment system is configured to lower the height of the header row unit in response to detecting lodged stalks.

6. The header height sensor system of claim 4, wherein the array of Time-of-Flight sensors sample distances at about 10 Hz or greater.

7. The header height sensor system of claim 6, wherein adjustments are made by the height adjustment system after threshold number of samples detect an object above ground.

8. The header height sensor system of claim 7, wherein the threshold number of samples is six or greater.

9. The header height sensor system of claim 1, further comprising at least one radar sensor in communication with the processor configured to sense distance to ground.

10. A header height sensor system, comprising:
(a) a first non-contact height sensor disposed on a corn header snoot; and
(b) a processor in communication with the first non-contact height sensor,
wherein the processor is configured to detect objects above a ground by samples of distance data from the first non-contact height sensor.

11. The header height sensor system of claim 10, wherein the first non-contact height sensor is a Time-of-Flight (ToF) sensor array configured to measure height at more than one projection point.

12. The header height sensor system of claim 11, wherein the first non-contact height sensor is configured to measure height at at least four projection points.

13. The header height sensor system of claim 11, wherein an object above the ground is detected when there is a threshold amount of difference in the measured heights.

14. The header height sensor system of claim 13, further comprising a header height adjustment mechanism wherein the processor is commands adjustments to a header height in response to detected objects.

15. The header height sensor system of claim 10, further comprising at least one contact sensor disposed on a superior surface of the corn header snoot configured to detected lodged stalks passing over the corn header snoot.

16. The header height sensor system of claim 10, further comprising at least one forward facing vision sensor configured to detect changes to terrain slope.

17. The header height sensor system of claim 16, further comprising a header height adjustment mechanism wherein the processor is commands adjustments to a header height in response to changes in terrain slope.

18. The header height sensor system of claim 10, further comprising a memory in communication with the processor, wherein locations for detected objects are stored in the memory.

19. The header height sensor system of claim 10, wherein the first non-contact height sensor is disposed at a tip of the corn header snoot and further comprising a second non-contact height sensor disposed at a rear of the corn header snoot.

20. A system for adjusting a corn header height, comprising:
(a) a first Time-of-Flight (ToF) sensor array disposed at a tip of a snoot configured to detect height at more than one projection point;
(b) a second ToF sensor array disposed at a rear of a snoot configured to detect height at more than one projection point;
(c) a processor in communication with the first ToF sensor and the second ToF sensor configured to compare heights at each of the projection points to determine if a lodged stalk is beneath the snoot; and
(d) a corn header height adjustment mechanism configured to be commanded by the processor to lower when lodged stalks are beneath the snoot.
